(19) United States
(12) Patent Application Publication
(10) Pub. No.: US 2023/0118994 A1
(43) Pub. Date: Apr. 20, 2023

(54) SERVERLESS FUNCTION INSTANCE PLACEMENT AMONG STORAGE TIERS

(71) Applicant: Intel Corporation, Santa Clara, CA (US)

(72) Inventors: Hong ZHANG, San Jose, CA (US); Rui ZANG, Beijing (CN); Xinran WANG, Beijing (CN); Yingchun GUO, Beijing (CN)

(21) Appl. No.: 17/991,807

(22) Filed: Nov. 21, 2022

(30) Foreign Application Priority Data
Nov. 1, 2022 (WO) PCT/CN2022/128984

(51) Int. Cl. G06F 3/06; G06F 16/185

(52) U.S. Cl. CPC G06F 3/0604; G06F 3/064; G06F 3/0685; G06F 16/185

(57) ABSTRACT

Examples described herein relate to selecting a compute node to execute the function based on latency of retrievals of function data blocks, wherein the function data blocks comprise at least a portion of an image of the function and the function data blocks are stored among two or more tiers of storage. In some examples, a latency of retrievals of function data blocks is based on storage of the function data blocks in devices of one or more storage tiers and retrieval latency to a memory utilized to launch the function.

### RELATED APPLICATION

This application claims the benefit of priority to Patent Cooperation Treaty (PCT) Application No. PCT/CN2022/128984 filed Nov. 1, 2022. The entire contents of that application are incorporated by reference.

### BACKGROUND

FIG. 1 depicts a computing node that includes processors and multiple tiers of memory or storage. For example, memory or storage can include dynamic random access memory (DRAM), persistent memory (PMEM), local solid state drive (SSD), and a shared storage tier. The computing node can include a processor that can execute instructions to process data stored in the memory or storage. In some examples, DRAM can have lower access times and latency of access than PMEM, PMEM can have lower access times and latency of access than SSD, and SSD can have lower access times and latency of access than shared storage.

Hierarchical storage management (HSM) is a data storage technique that moves data between storage media. HSM can utilize a data migration policy based on one or more of: Least Recently Used (LRU), Size-Temperature Replacement (STP), Heuristic Threshold (STEP), and so forth. In HSM, data can be moved after container image data has been accessed one or more times.

### BRIEF DESCRIPTION OF THE DRAWINGS

FIG. 1 depicts a node with multiple tiers of memory or storage.

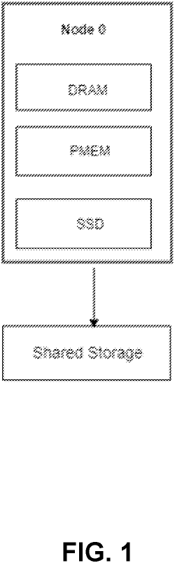

FIG. 2A depicts an example system.

FIG. 2B depicts an example of image blocks.

FIG. 3 depicts an example test run container image uploading process.

FIG. 4 depicts an example of identification of images accessed by various functions.

FIG. 5 depicts an example process.

FIG. 6 depicts an example operation.

FIG. 7 depicts an example operation to place images in one or more tiers of memory or storage devices.

FIG. 8 depicts an example operation to place a function.

FIG. 9 depicts an example system.

FIG. 10 depicts an example system.

FIG. 11 depicts an example system.

### DETAILED DESCRIPTION

Function as a service (FaaS) is a cloud computing execution system in which a cloud provider configures an operating running environment on demand to execute the function code in response to a trigger event. A micro virtual machine (microVM) refers to an execution environment in which the function code executes. In some cases, the FaaS system creates the microVM in response to the trigger event. In a cloud-native orchestration flow, after selecting a node to host and execute a function (e.g., container), the container image is to be loaded to the memory of the host from a remote image repository. During cold start, function code in a container image format can be copied from a remote image registry to a memory of a node that executes the function. Loading of the container image includes downloading the container image segment data from the remote image repository to the node’s local storage over the network and then loading the image segment data from the node’s local storage to the node’s memory. Time to copy the function code can contribute to cold start latency. The larger the function code image, the more image segment data is to be moved, and the longer the cold start latency.

Different function images can share some common image blocks or segments. An image block of a function instance may be stored on a certain node or a certain storage tier due to a previous run of another function. A storage tier in a distributed storage hierarchy presents a unique accessing cost from a node’s perspective. The factors impacting the accessing cost includes the type of storage media and the distance of the storage media to the node’s memory. As a function being cold started on a node involves downloading image segments from different storage tiers, the distribution pattern of the image segments impacts the cold start latency and the closer these storage tiers to the node (less duration of loading image segment data to memory prior to launching a container) and the more needed image segments exist on those storage tiers (less image segment data to be downloaded), the lower the function startup latency.

A function can be composed of one or more image segments and during execution of a function, the image segments can be copied into memory from their memory or storage locations in a hierarchical storage environment. At least to attempt to reduce cold start latency of a function, function placement process can consider movement latency of the function image’s image segments from a memory or storage tier or device that store one or more image segments of the function image in selecting a compute node to execute a function instance.

At least to attempt to reduce cold start latency of a function, portions of image segments can be stored to one or more tiers of storage or memory based on an image block’s access frequency, sequence of image block access, and/or number of functions executing on a hosting node that access the image block. An importance index of an image block can be determined based on the image block’s access frequency, sequence of image block access, and/or number of containers running on a hosting node that need to access this image block. Container image blocks can be copied or stored to tiers of the hierarchical storage based on the blocks’ importance index values to attempt to reduce latency of copying and loading the image blocks into a host node’s memory during function execution, to reduce container cold start latency.

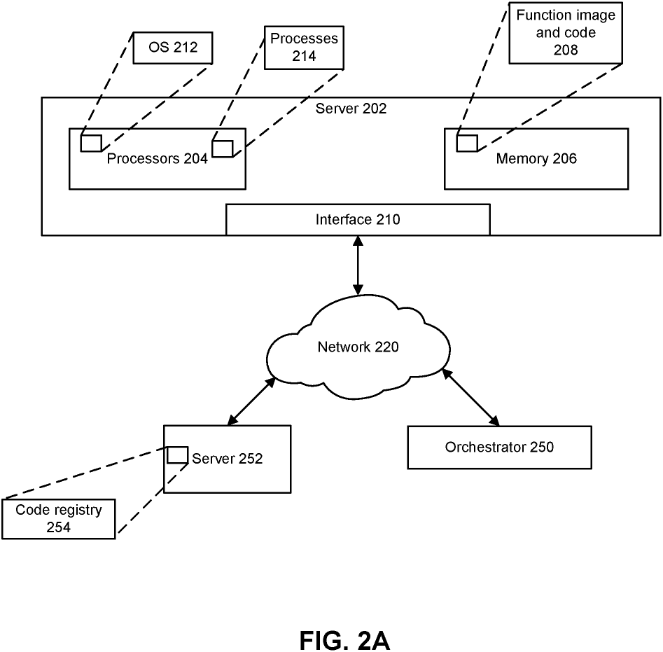

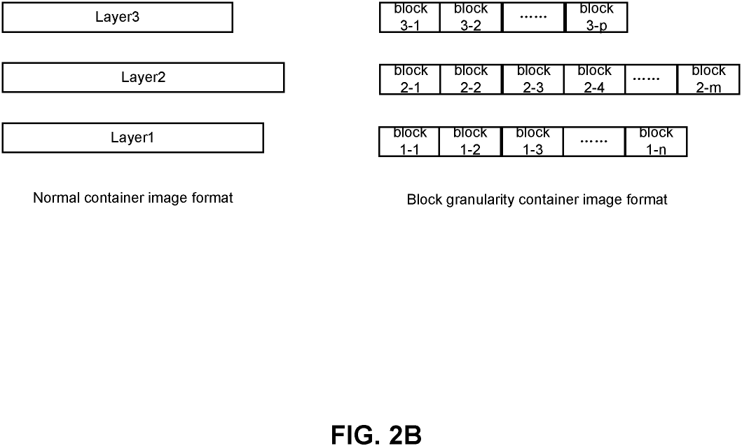

FIG. 2A depicts an example system. Server 202 can include or access one or more processors 204, memory 206, and device interface 210, among other components described herein (e.g., accelerator devices, interconnects, and other circuitry). Various examples of processors 204 are described herein. Processors 204 can execute one or more processes 214 (e.g., applications, functions, microservices, virtual machines (VMs), microVMs, containers, or other distributed or virtualized execution environments) that are launched as described herein. Note that applications, functions, microservices, virtual machines (VMs), microVMs, containers, or other distributed or virtualized execution environments can be used interchangeably.

A virtualized execution environment (VEE) can include at least a microVM, virtual machine, or a container. A microVM can be used to isolate an untrusted computing operation from a computer’s host operating system. A microVM can execute in a server that runs a host operating system (OS). A microVM engine can access the OS and can provide an application programming interface (API), network, storage and management capabilities to operate microVMs. The micro VM engine can create isolated virtual instances that can run a guest OS and a workload. For example, microVMs can be created and managed by Linux Kernel-based Virtual Machine (KVM), QEMU, Amazon Web Services (AWS).

A virtual machine (VM) can be software that runs an operating system and one or more applications. A VM can be defined by specification, configuration files, virtual disk file, non-volatile random access memory (NVRAM) setting file, and the log file and is backed by the physical resources of a host computing platform. A VM can include an operating system (OS) or application environment that is installed on software, which imitates dedicated hardware. The end user has the same experience on a virtual machine as they would have on dedicated hardware. Specialized software, called a hypervisor, emulates the PC client or server’s CPU, memory, hard disk, network and other hardware resources completely, enabling virtual machines to share the resources. The hypervisor can emulate multiple virtual hardware platforms that are isolated from another, allowing virtual machines to run Linux®, Windows® Server, VMware ESXi, and other operating systems on the same underlying physical host.

A container can be a software package of applications, configurations and dependencies so the applications run reliably on one computing environment to another. Containers can share an operating system installed on the server platform and run as isolated processes. A container can be a software package that contains everything the software needs to run such as system tools, libraries, and settings. Containers may be isolated from the other software and the operating system itself. The isolated nature of containers provides several benefits. First, the software in a container will run the same in different environments. For example, a container that includes PHP and MySQL can run identically on both a Linux® computer and a Windows® machine. Second, containers provide added security since the software will not affect the host operating system. While an installed application may alter system settings and modify resources, such as the Windows registry, a container can only modify settings within the container.

Various examples of processes 214 include an application composed of microservices, where a microservice runs in its own process and communicates using protocols (e.g., application program interface (API), a Hypertext Transfer Protocol (HTTP) resource API, message service, remote procedure calls (RPC), or Google RPC (gRPC)). Microservices can communicate with one another using a service mesh and be executed in one or more data centers or edge networks. Microservices can be independently deployed using centralized management of these services. The management system may be written in different programming languages and use different data storage technologies. A microservice can be characterized by one or more of: polyglot programming (e.g., code written in multiple languages to capture additional functionality and efficiency not available in a single language), or lightweight container or virtual machine deployment, and decentralized continuous microservice delivery.

Processes 214 can perform packet processing based on one or more of Data Plane Development Kit (DPDK), Storage Performance Development Kit (SPDK), OpenDataPlane, Network Function Virtualization (NFV), software-defined networking (SDN), Evolved Packet Core (EPC), or 5G network slicing. Some example implementations of NFV are described in ETSI specifications or Open Source NFV Management and orchestration (MANO) from ETSI’s Open Source Mano (OSM) group. A virtual network function (VNF) can include a service chain or sequence of virtualized tasks executed on generic configurable hardware such as firewalls, domain name system (DNS), caching or network address translation (NAT) and can run in VEEs. VNFs can be linked together as a service chain. In some examples, EPC is a 3GPP-specified core architecture at least for Long Term Evolution (LTE) access. 5G network slicing can provide for multiplexing of virtualized and independent logical networks on the same physical network infrastructure. Some applications can perform video processing or media transcoding (e.g., changing the encoding of audio, image or video files).

In some examples, OS 212 can be consistent with Linux®, Windows® Server or personal computer, FreeBSD®, Android®, MacOS®, iOS®, VMware vSphere, openSUSE, RHEL, CentOS, Debian, Ubuntu, or any other operating system. OS 212 and driver can execute on a processor sold or designed by Intel®, ARM®, AMD®, Qualcomm®, IBM®, Nvidia®, Broadcom®, Texas Instruments®, among others.

Memory device 206 can include one or more of: one or more registers, one or more cache devices (e.g., level 1 cache (L1), level 2 cache (L2), level 3 cache (L3), last level cache (LLC)), one or more volatile memory device, one or more non-volatile memory device, one or more persistent memory device, dual in-line memory modules (DIMMs), or one or more of memory pools. A memory pool can be accessed as a local device or a remote memory pool through a device interface, switch, or network. A memory pool can be shared by multiple servers or processors. Memory device 206 can include multiple tiers of memory or storage and can include at least two levels of memory (alternatively referred to herein as “2LM” or tiered memory) can be used that includes cached subsets of system disk level storage (in addition to, for example, runtime data). This main memory includes a first level (alternatively referred to herein as “near memory”) including lower latency and/or higher bandwidth memory made of, for example, dynamic random access memory (DRAM) or other volatile memory; and a second level and potentially subsequent level (alternatively referred to herein as “far memory”) which includes higher latency and/or lower bandwidth (with respect to the near memory) volatile memory (e.g., DRAM) or nonvolatile memory storage (e.g., flash memory or byte addressable non-volatile memory (e.g., Intel Optane®)). The far memory can be presented as “main memory” to the host operating system (OS), while the near memory can include a cache for the far memory that is transparent to the OS. The management of the two-level memory may be performed by a combination of circuitry and modules executed via the host central processing unit (CPU). Near memory may be coupled to the host system CPU via high bandwidth, low latency connection for low latency of data availability. Far memory may be coupled to the CPU via low bandwidth, high latency connection (as compared to that of the near memory), via a network or fabric, or a similar high bandwidth, low latency connection as that of near memory. Far memory devices can exhibit higher latency or lower memory bandwidth than that of near memory.

Memory 206 can store function image and code 208 that can be used as a seed to launch a function instance, as described herein. For example, function image and code 208 can include primary code segments grouped into one or more image segments, one or more code package or file (.pkg1) as well as secondary code segments grouped into a code package or file (.pkg2) as well as an order of launch or download of one or more primary code segments and one or more secondary code segments. In some examples, function image and code 208 can include one or more executable binaries or device images to be executed by a field programmable gate array (FPGA) or configuration profiles of an application specific integrated circuit (ASIC). Function image and code can include image blocks stored in an overlay file system as multiple container layers and a layer can include multiple image blocks.

In some examples, disaggregated or composite servers can be formed from one or muliple servers to execute workloads of FasS. Multi-tenant environments can be supported by the disaggregated or composite servers. Workloads from different tenants can be executed for different tenants. In some examples, a workload can include one or more operations to perform on behalf of process 214 or one or more operations of process 214.

Interface 210 can be used to communicate via network 220 with server 252 and/or orchestrator 250. Interface 210 can be implemented as one or more of: a network interface controller (NIC), a remote direct memory access (RDMA)-enabled NIC, SmartNIC, router, switch, forwarding element, infrastructure processing unit (IPU), data processing unit (DPU), or device interface. A device interface can be consistent with Peripheral Component Interconnect Express (PCIe), Compute Express Link (CXL), or other connection technologies. See, for example, Peripheral Component Interconnect Express (PCIe) Base Specification 1.0 (2002), as well as earlier versions, later versions, and variations thereof. See, for example, Compute Express Link (CXL) Specification revision 2.0, version 0.7 (2019), as well as earlier versions, later versions, and variations thereof.

In some examples, orchestrator 250 can request cold start of FaaS or functions for execution on server 202. Examples of orchestrator 250 include Amazon Lambda, Microsoft Azure function, Google CloudRun, Knative, Azure, or others. Code registry 254 can store function code used to create a prior running instance of the function. As described herein, during a prior execution of one or more processes 214, orchestrator 250 can determine an importance index can be determined and image blocks of the one or more more processes 214 can be stored in one or more tiers of memory 206 based on importance index values. As described herein, orchestrator 250 can determine one or more candidate nodes (e.g., servers) that can execute a process and select a target node to execute the process based on proximity to data blocks of an image of the process.

In some example, interface 210 can determine and image block placement based on importance index values and reserve processors 204 and memory 206 for storing image blocks and running the processes 214.

FIG. 2B depicts an example of image blocks. Function or container data can be stored as an overlay file system that includes multiple container layers. For example, one or more layers of a container image can be stored as image blocks of block granularity container images.

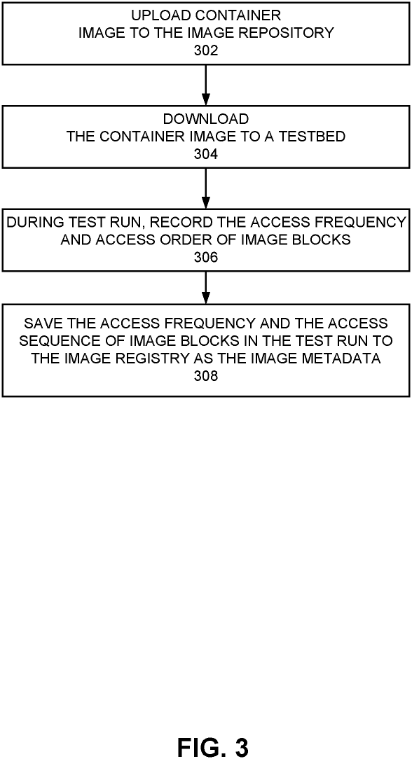

FIG. 3 depicts an example test run container image uploading process. In some examples, the process can be performed by a processor at the direction of an orchestrator, virtual machine manager, hypervisor, or other software. The orchestrator, virtual machine manager, or hypervisor can execute on a same node or different node than that which launches a function. An example of a node includes a server, memory pool, storage pool, and/or network interface device. A trigger event such as a scheduled or requested execution of a function can lead to execution of the process. Note that while description of the container image is with regard to a test run, the container image can be executed as part of an execution of the container, that is not a test run. At 302, a container image can be uploaded to an image repository. For example, an uploaded container image can include source and/or binary machine-readable code written in one or more languages (e.g., Python, Go, Java, Node.JS) as well as dependent libraries and data which are to be consumed by the code. For example, a container can be uploaded to image repository such as Docker hub to be pulled for execution on a node.

At 304, the container image can be downloaded from the image repository to a node (e.g., computing platform) to execute. For example, execution of a container image can include: loading and initializing (init) a language runtime, importing or loading function dependencies, initializing function variables such as unique function identifiers (IDs), setting up a connection to other services or servers via a fabric or network, opening files, reading environment variables, and/or initiating the function handler.

At 306, during a test run or one or more prior executions of the container image, meta data can be recorded. For example, metadata can include access frequency of image blocks as well as access order of image blocks by the container image. At 308, metadata for the container image can be stored. The process can be repeated for different code segments to determine an importance index or data placement based on metadata for multiple container images. The medatata can be saved in JSON format. For example, for a docker image, JSON data can be saved as a label of a Docker image object (e.g., “importance_index.blocks.metadata”) which can be accessed at least using docker inspect. An example of metdata is as follows:

“Labels”: {
“importance_index.blocks.metadata”:
“[{“LBA”:“1”,“frequency”:“5”,“sequence”:“8”},{“LBA”:“2”,“frequency”:“10”,“sequence
”:“3”},......{“LBA”:“128”,“frequency”:“2”,“sequence”:“1”}]”
}

For example, an importance index of an image block can be calculated based on one or more of the following: (1) image block’s access frequency during a start up and execution of the container, (2) number of containers running on the hosting node that, during execution, are to access the image block, or (3) sequence of access of the image block (e.g., relative order of access by the container during execution of the container). The higher the image block’s access frequency, the higher importance index for the image block. The more number of running containers on the node that are to access the image block, the higher the importance index for the image block. The earlier an image block is to be accessed by the container, the higher the importance index for the image block.

Below are example calculations of an importance index:
(1) Importance index = access frequency * number of containers - access sequence number
(2) Importance index = (access frequency * number of containers) / access sequence number

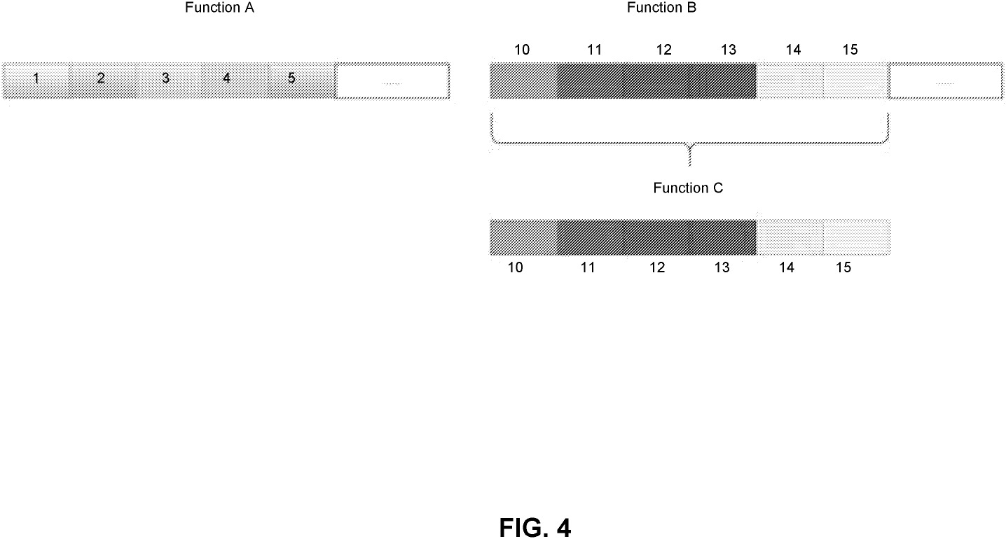

FIG. 4 depicts an example of identification of data accessed by various functions. Functions A, B, and C can be implemented as one or more of: an application, microservice, virtual machine (VM), microVM, container, or other distributed or virtualized execution environments. In this example, function A can access data 1-5 whereas function B and function C can access data 10-15. As functions B and C both access data 10-15, data 10-15 can be stored in one or more memory or storage devices and devices can be selected to execute functions B and C to reduce an amount of latency to access data 10-15 by functions B and C, as described herein.

Some examples select a node to host and execute a function instance based on storage of one or more image segments accessed to start or execute the function instance among storage tiers in a cloud cluster. Some of the storage tiers can include local storage to that node and accessible through a device interface while other storage tiers can be remote storage shared with one or more other nodes in a cluster and accessible through a network or fabric interface. For one or more nodes, a cost value to download or move the function’s image segments from one or more storage tiers to the node’s local memory for access by the function instance. In some examples, a cost value can be calculated as follows:
cost value = Sum of Ni*Wi
where i = storage tier,
   Ni denotes a number of image segments that already are stored in storage tier i, and
   Wi indicates a latency value to access data from the storage tier (e.g., fast storage tier (cache) Wi = 1 whereas a slow storage tier (disk drive) Wi = 100).
In some examples, an image segment may be stored in multiple storage tiers, but the cost of that image segment in the highest performance storage tier (fastest and lowest latency) can be counted in the cost value calculation.

For a function instance, cost value can be calculated for data used by the function during startup or execution and a node with a lowest cost value can be chosen to host and execute the function instance. Reducing a cost value can reduce function loading latency and cold start latency.

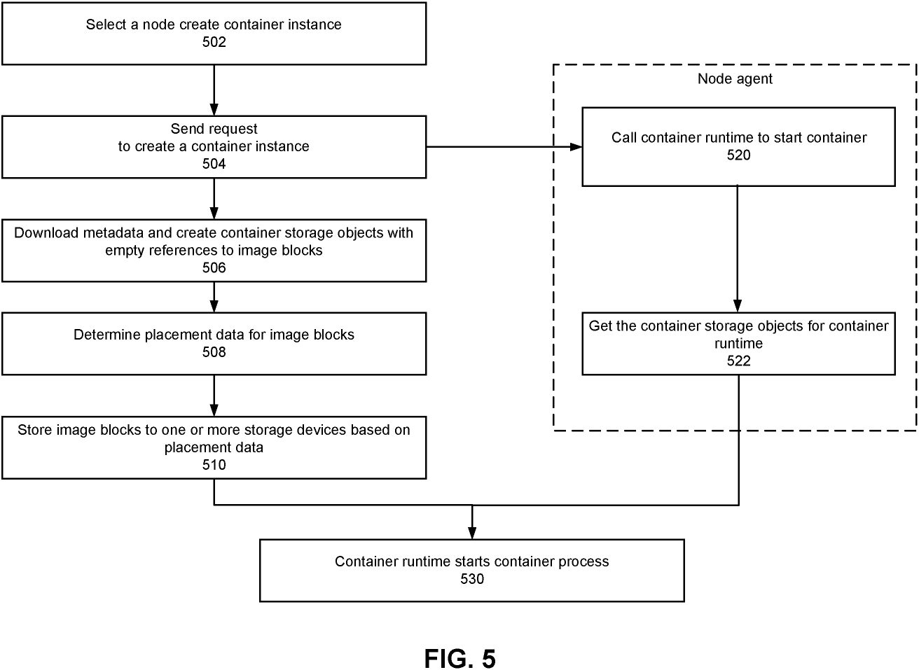

FIG. 5 depicts an example process. The process can be performed by an orchestrator and/or a node agent, in some examples. At 502, based on receipt of a request to launch a container for execution, one or more nodes can be selected to create a container instance. While examples are described with respect to containers, the process of FIG. 5 can apply to other virtual execution environments. For example, a system scheduler can perform 502. In some examples, a system scheduler can include Cloud Native Computing Foundation (CNCF) Kubernetes scheduler, Apache Mesos scheduler, Docker swarm scheduler, and so forth.

At 504, a request to create a container instance can be sent to a node agent. The node agent can execute on a compute node. In some examples, a node agent can apply, create, update, or destroys containers executed on one or more nodes. In some examples, a node agent can include a Kubernetes kubelet, Mesos agent, or others. In some examples, the system scheduler can notify a system image loading component that a container instance is to be created when or before sending the request to create a container instance to the node agent to create the container.

At 506, metadata for the container can be downloaded and a logical container storage object can be constructed based on the metadata. A container storage object can be a logical representation of a container image on a compute node. A container storage object can include a logical structure with pointers to where one or more image blocks that are part of the container image are stored amongst one or more storage tiers. At this point, since the placement of one or more image blocks are not yet determined or can change, the logical container storage object can include one or more empty image blocks references (pointers). However, the logical container storage object can include one or more image blocks references (pointers) to storage locations and addresses of one or more image blocks. For example, a system image loading component that executes on one or more compute nodes can perform 506. Metadata can include a number of times at least one image block was accessed over a complete life cycle of a function test run or prior run as well as access order of image blocks by the container image. Metadata can be part of the container image or separate from the container image.

At 508, for one or more image blocks referenced by the logical container storage object, placement data or importance index can be determined. For example, placement data or importance index can provide information used to determine where to store image blocks in one or more storage or memory tiers or devices. Placement data or importance index can be based on metadata such as access frequency and access sequence, and/or the number of containers running on one or more nodes that access this image block. For example, an image loading software executed on a compute node can perform 508.

At 510, image blocks referenced by the logical container storage object can be copied into one or more memory or storage devices based on placement data such as an importance index. For example, high importance index blocks can be stored to high-performance storage or lower latency memory tiers (e.g., cache or memory) and low importance index blocks can be stored to low-performance storage tiers (e.g., SSD or shared storage). At 510, references to storage addresses and storage or memory devices that store image blocks can be inserted into the empty references in the logical container storage object. For example, an image loading software executed on one or more compute nodes can perform 510. By distributing image blocks according to placement data or importance index, the cold start latency of a container can be reduced potentially.

At 520, a container runtime can be called to start a container instance. For example, a node agent can call the container runtime. At 522, container storage objects for the container runtime can be retrieved from image loading component. At 522, namespaces can be created for at least process namespaces and network namespaces for resource isolation for isolation of resources. Various examples of determination of one or more nodes to execute the container are described herein and can be based on storage devices that store data accessed by the container.

At 530, a container runtime can commence execution of the container process. A container process can include an operating system process confined in a container execution environment, processor-executed instructions, and access a memory footprint, and so forth. For example, data identified in the references to image blocks can be retrieved for the container process.

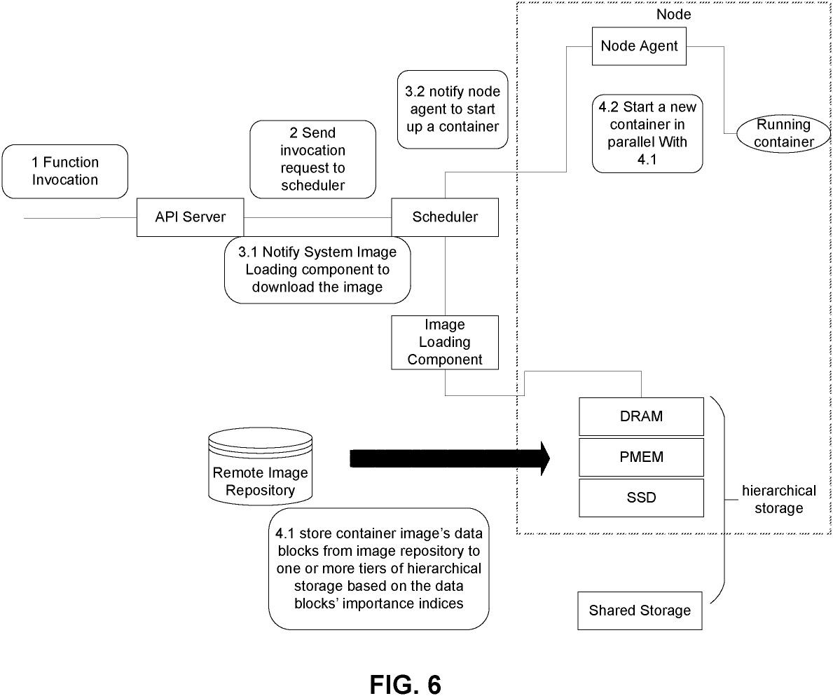

FIG. 6 depicts an example operation to execute a container process. At (1), a function invocation can be issued by an event source to an API server. Examples of an API server include CNCF Istio API gateway, CNCF Contour, Kong API Gateway, or others. At (2), API server can send an invocation request to a scheduler. At (3.1), the scheduler can cause downloading of a container image. At (3.2), the scheduler can cause a node agent to start a container image requested to be invoked at (1). For example, an example scheduler can include CNCF Kubernetes scheduler, Apache Mesos scheduler, Docker swarm scheduler, or others. Operations of 3.1 and 3.2 can overlap at least partially in time. At (4.1), the container image’s image blocks from the image repository can be copied to different tiers of the hierarchical storage based on the blocks’ placement data or importance index. At (4.2), a container can be started. Operations of 4.1 and 4.2 can overlap at least partially in time as image blocks can be downloaded as the container starts. While a container starts, it will access image blocks, but not all image blocks, and all image blocks of the container image need not be retrieved before starting the container, although one or more image blocks of the container can be retrieved before starting the container. Image blocks can be downloaded in order according to importance index, determined based on a access sequence from a prior execution of the container. Earlier accessed image blocks can be downloaded prior to later accessed image blocks.

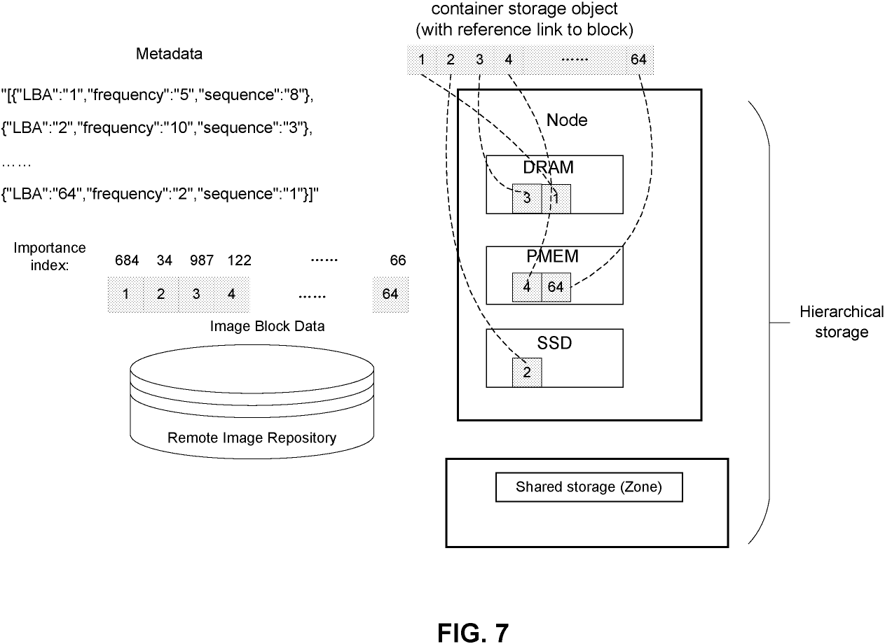

FIG. 7 depicts an example operation to place data in one or more tiers of memory or storage devices. An image loader or other software or hardware can download a container image’s image blocks to one or more tiers of the hierarchical storage based on the blocks’ importance index and add location references to the container storage objects. An importance index of an image block can be based on its access frequency, access sequence, and/or the number of containers running on the hosting node that access this image block. For example, an importance index can be associated with image blocks 1-64. In this example, image blocks 1-64 correspond to respective LBAs 1-64. Image block 1 is determined to be accessed 5 times during a prior execution of the container, image block 2 is determined to be accessed 10 times during a prior execution of the container, and so forth. In this example, image blocks 1 and 3 have the highest importance index values because of frequency of access and access sequence and can be stored in lowest access latency memory, DRAM. Image blocks 4 and 64 have the next highest importance index values of 122 and 66 and can be stored in next lowest access memory, persistent memory (PMEM). Image block 2 has the next highest importance index values of 2 and can be stored in a next lowest access storage, solid state drive (SSD). Other image blocks with lower importance index values can be stored in shared storage, such as a storage node.

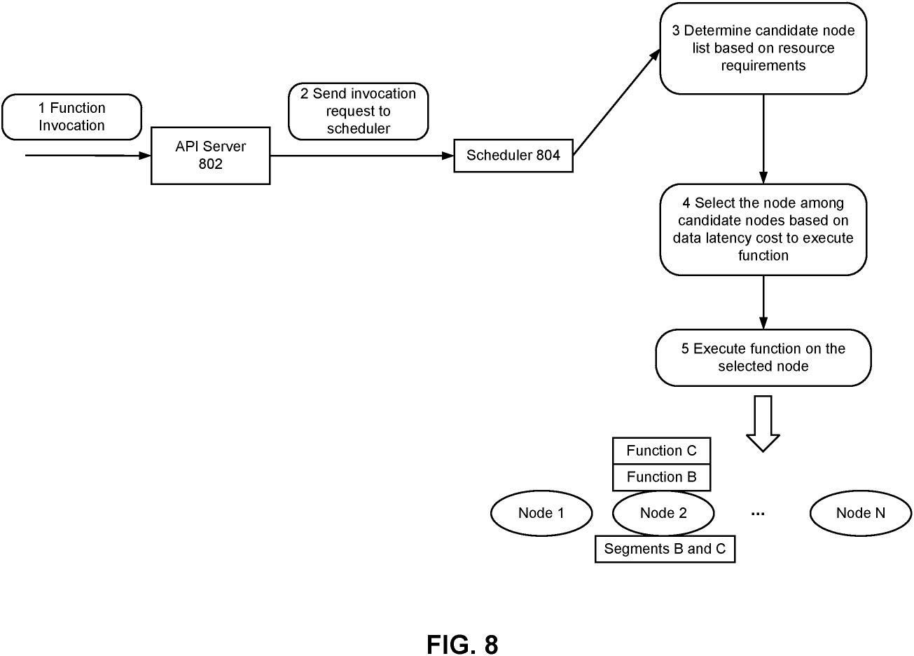

FIG. 8 depicts an example operation to place a function (e.g., container or other virtualized execution environment) and associated image block(s) used to start or execute the function. At (1), a function invocation can be issued by an application to API server 802. An application can include a web browser, smartphone application, a triggering event such as a video camera alert or user input, or others. Example orchestrators can include CNCF Kubernetes, Docker swarm, Amazon Lambda, Microsoft Azure function, Google CloudRun, Knative, Azure, or others. At (2), API server 802 can send an invocation request to scheduler 804. At (3), scheduler 804 can determine one or more candidate nodes for execution of the function based on the one or more candidate nodes including hardware and software resources that meet the function resource requirement. Function resource requirements can include one or more of: processor type (e.g., CPU, GPU), processor frequency of operation, amount of memory, amount of storage, type of accelerator device to utilize (e.g., encryption, decryption, compression, decompression), system software (e.g., OS, drivers), network interface controller transmission bandwidth, and so forth. At (4), scheduler 804 can calculate a movement cost of image segments (e.g., time consumed to transport container data) for start-up and/or execution of an image of the function to one or more candidate node’s memory. At (4), scheduler 804 can select one or more nodes with the lowest cost as the selected node(s) to execute the function. At (5), scheduler 804 can cause the function to be placed for execution on the one or more selected nodes. Thereafter the function can be started using image segments. In some examples, an orchestrator can include API server 802 and scheduler 804.

With reference to the image block sharing diagram of FIG. 4 and the operation of FIG. 8, for example, at (1), at least one request can be received to schedule execution of Function A and Function B. Because Function A and Function B have different hardware and software requirements, scheduler 804 schedules them for execution on different candidate nodes. For example, Function A can be scheduled for execution on node 1 whereas Function B can be scheduled for execution on node 2. A request is received to schedule and run Function C with no specific hardware or software requirements. Because Function C has no specific hardware or software requirements, it can be scheduled to execute on a node in a cloud node cluster. Scheduler 804 can select a function that has most image blocks shared with Function C and execute Function C on a same node as the selected function. In this example, Function B shares more image blocks with function C than Function B shares with Function A. Note that after Function B is scheduled to execute on node 2, image segments included in Function B and Function C (shown as Segments B and C) can be loaded to storage tiers that are closest to node 2. Thus, node 2 could have a smallest loading latency of the image segments included in Function C.

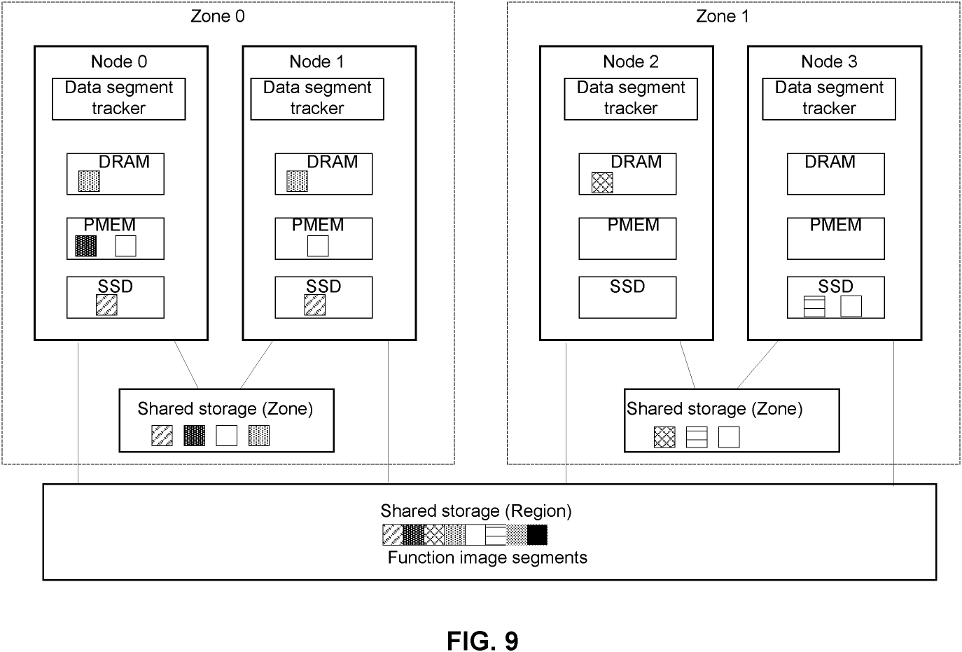

FIG. 9 depicts an example cloud cluster with two availability zones in a geographical region, namely zone 0 and zone 1. Zone 0 can include nodes 0 and 1 whereas zone 1 can include nodes 2 and 3. In this example, nodes 0-3 include three tiers of local storage or memory: memory (e.g., DRAM), persistent memory (PMEM), and solid state drive (SSD). Nodes 0 and 1 of zone 0 can access image segments from a shared storage tier and a region level shared storage tier. Similarly, nodes 2 and 3 of zone 1 can access a shared storage tier and a region level shared storage tier. A shared storage tier can store image segments also stored in DRAM, PMEM, and SSD. A region level shared storage tier can store image segments to be accessed by a container.

Cost values can represent a latency code for storing image segments accessed by a container in memory and storage devices. Table 1 provides examples of image segment access latency cost values of a container executing on nodes 0, 1, 2, or 3.

TABLE 1

| Node | DRAM | | PMEM | | SSD | | Shared storage (zone) | | Shared storage(region) | | Cost Value |
|---|---|---|---|---|---|---|---|---|---|---|---|
| | Late ncy valu e | Numb er of image segme nts | Late ncy value | Num ber of imag e segm ents | Late ncy valu e | Numb er of image segme nts | Late ncy value | Numb er of image segme nts | Late ncy value | Number of image segment s | |
| Node 0 | 1 | 1 | 10 | 2 | 50 | 1 | 100 | 0 | 200 | 4 | 871 |
| Node 1 | 1 | 1 | 10 | 1 | 50 | 1 | 100 | 1 | 200 | 4 | 961 |
| Node 2 | 1 | 1 | 10 | 0 | 50 | 0 | 100 | 2 | 200 | 5 | 1201 |
| Node 3 | 1 | 0 | 10 | 0 | 50 | 2 | 100 | 1 | 200 | 5 | 1200 |

Image segments to be accessed to start the container can be stored in shared region storage and in some cases, DRAM, PMEM, SSD, and/or shared zone storage. In this example, execution of a container on Node 0 provides a lowest image segment access latency cost value for image segments to be retrieved to start the container. For example, DRAM of Node 0 stores 1 image segment that is accessed to start the container, PMEM of Node 0 stores 2 image segments that are accessed to start the container, SSD of Node 0 stores 1 image segment that is accessed to start the container, shared zone storage stores zero other image segments (not already stored in DRAM, PMEM, or SSD) that are accessed to start the container, and shared region storage stores 4 other image segments (not already stored in DRAM, PMEM, or SSD) that are accessed to start the container. Accordingly, the container can be scheduled to execute in Node 0.

Image segment tracker can identify to function scheduler where image segment are stored. The distribution pattern of the image segments in the hierarchical storage tiers can be based on one or more previous executions of a function before this scheduling request.

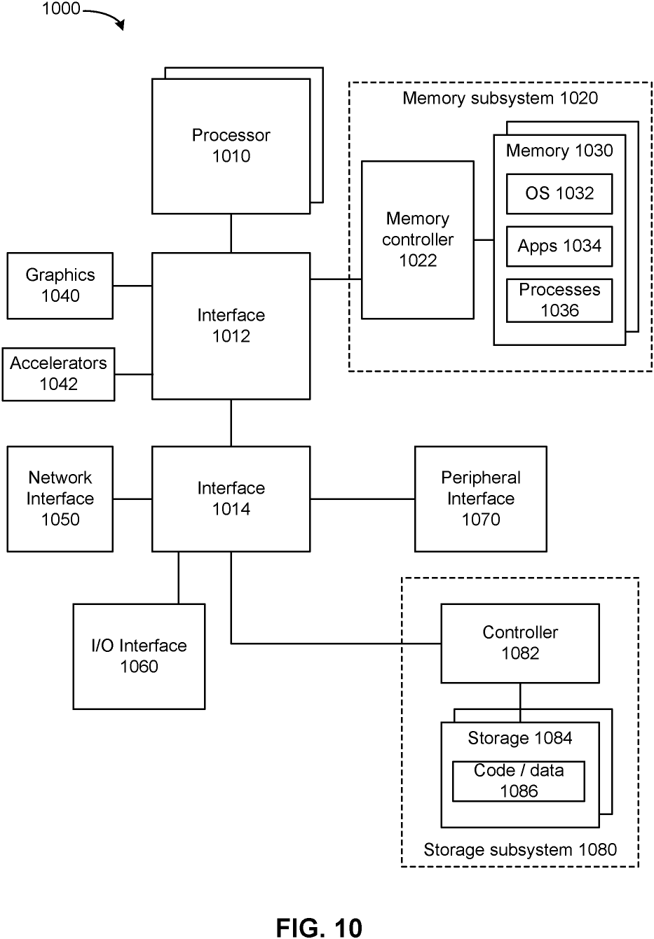

FIG. 10 depicts an example computing system that can be used in a server or data center. Components of system 1000 (e.g., processor 1010, accelerators 1042, and so forth) to perform operations to update mappings of received packets to target processes or devices can be updated, as described herein. System 1000 includes processor 1010, which provides processing, operation management, and execution of instructions for system 1000. Processor 1010 can include any type of microprocessor, central processing unit (CPU), graphics processing unit (GPU), processing core, or other processing hardware to provide processing for system 1000, or a combination of processors. Processor 1010 controls the overall operation of system 1000, and can be or include, one or more programmable general-purpose or special-purpose microprocessors, digital signal processors (DSPs), programmable controllers, application specific integrated circuits (ASICs), programmable logic devices (PLDs), or the like, or a combination of such devices.

In one example, system 1000 includes interface 1012 coupled to processor 1010, which can represent a higher speed interface or a high throughput interface for system components that needs higher bandwidth connections, such as memory subsystem 1020 or graphics interface components 1040, or accelerators 1042. Interface 1012 represents an interface circuit, which can be a standalone component or integrated onto a processor die. Where present, graphics interface 1040 interfaces to graphics components for providing a visual display to a user of system 1000. In one example, graphics interface 1040 can drive a high definition (HD) display that provides an output to a user. High definition can refer to a display having a pixel density of approximately 100 PPI (pixels per inch) or greater and can include formats such as full HD (e.g., 1080p), retina displays, 4K (ultra-high definition or UHD), or others. In one example, the display can include a touchscreen display. In one example, graphics interface 1040 generates a display based on data stored in memory 1030 or based on operations executed by processor 1010 or both. In one example, graphics interface 1040 generates a display based on data stored in memory 1030 or based on operations executed by processor 1010 or both.

Accelerators 1042 can be a fixed function or programmable offload engine that can be accessed or used by a processor 1010. For example, an accelerator among accelerators 1042 can provide compression (DC) capability, cryptography services such as public key encryption (PKE), cipher, hash/authentication capabilities, decryption, or other capabilities or services. In some embodiments, in addition or alternatively, an accelerator among accelerators 1042 provides field select controller capabilities as described herein. In some cases, accelerators 1042 can be integrated into a CPU socket (e.g., a connector to a motherboard or circuit board that includes a CPU and provides an electrical interface with the CPU). For example, accelerators 1042 can include a single or multi-core processor, graphics processing unit, logical execution unit single or multi-level cache, functional units usable to independently execute programs or threads, application specific integrated circuits (ASICs), neural network processors (NNPs), programmable control logic, and programmable processing elements such as field programmable gate arrays (FPGAs) or programmable logic devices (PLDs). Accelerators 1042 can provide multiple neural networks, CPUs, processor cores, general purpose graphics processing units, or graphics processing units can be made available for use by artificial intelligence (AI) or machine learning (ML) models. For example, the AI model can use or include one or more of: a reinforcement learning scheme, Q-learning scheme, deep-Q learning, or Asynchronous Advantage Actor-Critic (A3C), combinatorial neural network, recurrent combinatorial neural network, or other AI or ML model. Multiple neural networks, processor cores, or graphics processing units can be made available for use by AI or ML models.

Memory subsystem 1020 represents the main memory of system 1000 and provides storage for code to be executed by processor 1010, or data values to be used in executing a routine. Memory subsystem 1020 can include one or more memory devices 1030 such as read-only memory (ROM), flash memory, one or more varieties of random access memory (RAM) such as DRAM, or other memory devices, or a combination of such devices. Memory 1030 stores and hosts, among other things, operating system (OS) 1032 to provide a software platform for execution of instructions in system 1000. Additionally, applications 1034 can execute on the software platform of OS 1032 from memory 1030. Applications 1034 represent programs that have their own operational logic to perform execution of one or more functions. Processes 1036 represent agents or routines that provide auxiliary functions to OS 1032 or one or more applications 1034 or a combination. OS 1032, applications 1034, and processes 1036 provide software logic to provide functions for system 1000. In one example, memory subsystem 1020 includes memory controller 1022, which is a memory controller to generate and issue commands to memory 1030. It will be understood that memory controller 1022 could be a physical part of processor 1010 or a physical part of interface 1012. For example, memory controller 1022 can be an integrated memory controller, integrated onto a circuit with processor 1010.

In some examples, OS 1032 can be Linux®, Windows® Server or personal computer, FreeBSD®, Android®, MacOS®, iOS®, VMware vSphere, openSUSE, RHEL, CentOS, Debian, Ubuntu, or any other operating system. The OS and driver can execute on a CPU sold or designed by Intel®, ARM®, AMD®, Qualcomm®, IBM®, Texas Instruments®, among others.

While not specifically illustrated, it will be understood that system 1000 can include one or more buses or bus systems between devices, such as a memory bus, a graphics bus, interface buses, or others. Buses or other signal lines can communicatively or electrically couple components together, or both communicatively and electrically couple the components. Buses can include physical communication lines, point-to-point connections, bridges, adapters, controllers, or other circuitry or a combination. Buses can include, for example, one or more of a system bus, a Peripheral Component Interconnect (PCI) bus, a Hyper Transport or industry standard architecture (ISA) bus, a small computer system interface (SCSI) bus, a universal serial bus (USB), or an Institute of Electrical and Electronics Engineers (IEEE) standard 1394 bus (Firewire).

In one example, system 1000 includes interface 1014, which can be coupled to interface 1012. In one example, interface 1014 represents an interface circuit, which can include standalone components and integrated circuitry. In one example, multiple user interface components or peripheral components, or both, couple to interface 1014. Network interface 1050 provides system 1000 the ability to communicate with remote devices (e.g., servers or other computing devices) over one or more networks. Network interface 1050 can include an Ethernet adapter, wireless interconnection components, cellular network interconnection components, USB (universal serial bus), or other wired or wireless standards-based or proprietary interfaces. Network interface 1050 can transmit data to a device that is in the same data center or rack or a remote device, which can include sending data stored in memory. Network interface 1050 can perform operations to update mappings of received packets to target processes or devices can be updated, as described herein.

Some examples of network interface 1050 are part of an Infrastructure Processing Unit (IPU) or data processing unit (DPU) or utilized by an IPU or DPU. An xPU can refer at least to an IPU, DPU, GPU, GPGPU, or other processing units (e.g., accelerator devices). An IPU or DPU can include a network interface with one or more programmable pipelines or fixed function processors to perform offload of operations that could have been performed by a CPU. The IPU or DPU can include one or more memory devices. In some examples, the IPU or DPU can perform virtual switch operations, manage storage transactions (e.g., compression, cryptography, virtualization), and manage operations performed on other IPUs, DPUs, servers, or devices.

In one example, system 1000 includes one or more input/output (I/O) interface(s) 1060. I/O interface 1060 can include one or more interface components through which a user interacts with system 1000 (e.g., audio, alphanumeric, tactile/touch, or other interfacing). Peripheral interface 1070 can include any hardware interface not specifically mentioned above. Peripherals refer generally to devices that connect dependently to system 1000. A dependent connection is one where system 1000 provides the software platform or hardware platform or both on which operation executes, and with which a user interacts.

In one example, system 1000 includes storage subsystem 1080 to store data in a nonvolatile manner. In one example, in certain system implementations, at least certain components of storage 1080 can overlap with components of memory subsystem 1020. Storage subsystem 1080 includes storage device(s) 1084, which can be or include any conventional medium for storing large amounts of data in a nonvolatile manner, such as one or more magnetic, solid state, or optical based disks, or a combination. Storage 1084 holds code or instructions and data 1086 in a persistent state (e.g., the value is retained despite interruption of power to system 1000). Storage 1084 can be generically considered to be a “memory,” although memory 1030 is typically the executing or operating memory to provide instructions to processor 1010. Whereas storage 1084 is nonvolatile, memory 1030 can include volatile memory (e.g., the value or state of the data is indeterminate if power is interrupted to system 1000). In one example, storage subsystem 1080 includes controller 1082 to interface with storage 1084. In one example controller 1082 is a physical part of interface 1014 or processor 1010 or can include circuits or logic in both processor 1010 and interface 1014.

A volatile memory is memory whose state (and therefore the data stored in it) is indeterminate if power is interrupted to the device. An example of a volatile memory include a cache. A non-volatile memory (NVM) device is a memory whose state is determinate even if power is interrupted to the device.

A power source (not depicted) provides power to the components of system 1000. More specifically, power source typically interfaces to one or multiple power supplies in system 1000 to provide power to the components of system 1000. In one example, the power supply includes an AC to DC (alternating current to direct current) adapter to plug into a wall outlet. Such AC power can be renewable energy (e.g., solar power) power source. In one example, power source includes a DC power source, such as an external AC to DC converter. In one example, power source or power supply includes wireless charging hardware to charge via proximity to a charging field. In one example, power source can include an internal battery, alternating current supply, motion-based power supply, solar power supply, or fuel cell source.

In an example, system 1000 can be implemented using interconnected compute sleds of processors, memories, storages, network interfaces, and other components. High speed interconnects can be used such as: Ethernet (IEEE 802.3), remote direct memory access (RDMA), InfiniBand, Internet Wide Area RDMA Protocol (iWARP), Transmission Control Protocol (TCP), User Datagram Protocol (UDP), quick UDP Internet Connections (QUIC), RDMA over Converged Ethernet (RoCE), Peripheral Component Interconnect express (PCIe), Intel QuickPath Interconnect (QPI), Intel Ultra Path Interconnect (UPI), Intel On-Chip System Fabric (IOSF), Omni-Path, Compute Express Link (CXL), HyperTransport, high-speed fabric, NVLink, Advanced Microcontroller Bus Architecture (AMBA) interconnect, OpenCAPI, Gen-Z, Infinity Fabric (IF), Cache Coherent Interconnect for Accelerators (CCIX), 3GPP Long Term Evolution (LTE) (4G), 3GPP 5G, and variations thereof. Data can be copied or stored to virtualized storage nodes or accessed using a protocol such as NVMe over Fabrics (NVMe-oF) or NVMe.

Communications between devices can take place using a network, interconnect, or circuitry that provides chip-to-chip communications, chiplet-to-chiplet communications, die-to-die communications, packet-based communications, communications over a device interface, fabric-based communications, and so forth. A die-to-die communications can be consistent with Embedded Multi-Die Interconnect Bridge (EMIB).

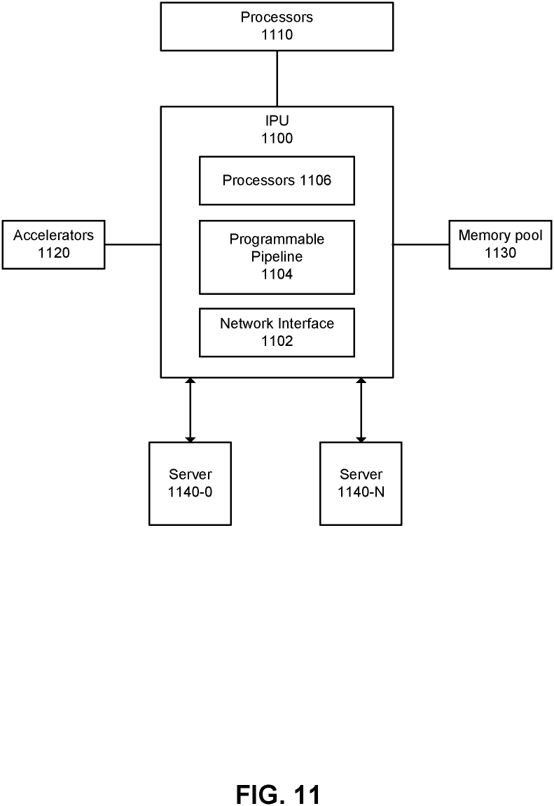

FIG. 11 depicts an example system. In this system, IPU 1100 manages performance of one or more processes using one or more of processors 1106, processors 1110, accelerators 1120, memory pool 1130, or servers 1140-0 to 1140-N, where N is an integer of 1 or more. In some examples, processors 1106 of IPU 1100 can execute one or more processes, applications, VMs, containers, microservices, and so forth that request performance of workloads by one or more of: processors 1110, accelerators 1120, memory pool 1130, and/or servers 1140-0 to 1140-N. IPU 1100 can utilize network interface 1102 or one or more device interfaces to communicate with processors 1110, accelerators 1120, memory pool 1130, and/or servers 1140-0 to 1140-N. IPU 1100 can utilize programmable pipeline 1104 to process packets that are to be transmitted from network interface 1102 or packets received from network interface 1102. Programmable pipeline 1104 and/or processors 1106 can be configured to perform function image block tracking, image block placement and/or image block access frequency counting during test run or one or more start-ups and executions of the function, as described herein.

Embodiments herein may be implemented in various types of computing, smart phones, tablets, personal computers, and networking equipment, such as switches, routers, racks, and blade servers such as those employed in a data center and/or server farm environment. The servers used in data centers and server farms comprise arrayed server configurations such as rack-based servers or blade servers. These servers are interconnected in communication via various network provisions, such as partitioning sets of servers into Local Area Networks (LANs) with appropriate switching and routing facilities between the LANs to form a private Intranet. For example, cloud hosting facilities may typically employ large data centers with a multitude of servers. A blade comprises a separate computing platform that is configured to perform server-type functions, that is, a “server on a card.” Accordingly, each blade includes components common to conventional servers, including a main printed circuit board (main board) providing internal wiring (e.g., buses) for coupling appropriate integrated circuits (ICs) and other components mounted to the board.

In some examples, network interface and other embodiments described herein can be used in connection with a base station (e.g., 3G, 4G, 5G and so forth), macro base station (e.g., 5G networks), picostation (e.g., an IEEE 802.11 compatible access point), nanostation (e.g., for Point-to-MultiPoint (PtMP) applications), on-premises data centers, off-premises data centers, edge network elements, fog network elements, and/or hybrid data centers (e.g., data center that use virtualization, cloud and software-defined networking to deliver application workloads across physical data centers and distributed multi-cloud environments).

Various examples may be implemented using hardware elements, software elements, or a combination of both. In some examples, hardware elements may include devices, components, processors, microprocessors, circuits, circuit elements (e.g., transistors, resistors, capacitors, inductors, and so forth), integrated circuits, ASICs, PLDs, DSPs, FPGAs, memory units, logic gates, registers, semiconductor device, chips, microchips, chip sets, and so forth. In some examples, software elements may include software components, programs, applications, computer programs, application programs, system programs, machine programs, operating system software, middleware, firmware, software modules, routines, subroutines, functions, methods, procedures, software interfaces, APIs, instruction sets, computing code, computer code, code segments, computer code segments, words, values, symbols, or any combination thereof. Determining whether an example is implemented using hardware elements and/or software elements may vary in accordance with any number of factors, such as desired computational rate, power levels, heat tolerances, processing cycle budget, input data rates, output data rates, memory resources, data bus speeds and other design or performance constraints, as desired for a given implementation. A processor can be one or more combination of a hardware state machine, digital control logic, central processing unit, or any hardware, firmware and/or software elements.

Some examples may be implemented using or as an article of manufacture or at least one computer-readable medium. A computer-readable medium may include a non-transitory storage medium to store logic. In some examples, the non-transitory storage medium may include one or more types of computer-readable storage media capable of storing electronic data, including volatile memory or non-volatile memory, removable or non-removable memory, erasable or non-erasable memory, writeable or re-writeable memory, and so forth. In some examples, the logic may include various software elements, such as software components, programs, applications, computer programs, application programs, system programs, machine programs, operating system software, middleware, firmware, software modules, routines, subroutines, functions, methods, procedures, software interfaces, API, instruction sets, computing code, computer code, code segments, computer code segments, words, values, symbols, or any combination thereof.

According to some examples, a computer-readable medium may include a non-transitory storage medium to store or maintain instructions that when executed by a machine, computing device or system, cause the machine, computing device or system to perform methods and/or operations in accordance with the described examples. The instructions may include any suitable type of code, such as source code, compiled code, interpreted code, executable code, static code, dynamic code, and the like. The instructions may be implemented according to a predefined computer language, manner or syntax, for instructing a machine, computing device or system to perform a certain function. The instructions may be implemented using any suitable high-level, low-level, object-oriented, visual, compiled and/or interpreted programming language.

One or more aspects of at least one example may be implemented by representative instructions stored on at least one machine-readable medium which represents various logic within the processor, which when read by a machine, computing device or system causes the machine, computing device or system to fabricate logic to perform the techniques described herein. Such representations, known as “IP cores” may be stored on a tangible, machine readable medium and supplied to various customers or manufacturing facilities to load into the fabrication machines that actually make the logic or processor.

The appearances of the phrase “one example” or “an example” are not necessarily all referring to the same example or embodiment. Any aspect described herein can be combined with any other aspect or similar aspect described herein, regardless of whether the aspects are described with respect to the same figure or element. Division, omission or inclusion of block functions depicted in the accompanying figures does not infer that the hardware components, circuits, software and/or elements for implementing these functions would necessarily be divided, omitted, or included in embodiments.

Some examples may be described using the expression “coupled” and “connected” along with their derivatives. These terms are not necessarily intended as synonyms for each other. For example, descriptions using the terms “connected” and/or “coupled” may indicate that two or more elements are in direct physical or electrical contact with each other. The term “coupled,” however, may also mean that two or more elements are not in direct contact with each other, but yet still co-operate or interact with each other.

The terms “first,” “second,” and the like, herein do not denote any order, quantity, or importance, but rather are used to distinguish one element from another. The terms “a” and “an” herein do not denote a limitation of quantity, but rather denote the presence of at least one of the referenced items. The term “asserted” used herein with reference to a signal denote a state of the signal, in which the signal is active, and which can be achieved by applying any logic level either logic 0 or logic 1 to the signal. The terms “follow” or “after” can refer to immediately following or following after some other event or events. Other sequences of operations may also be performed according to alternative embodiments. Furthermore, additional operations may be added or removed depending on the particular applications. Any combination of changes can be used and one of ordinary skill in the art with the benefit of this disclosure would understand the many variations, modifications, and alternative embodiments thereof.

Disjunctive language such as the phrase “at least one of X, Y, or Z,” unless specifically stated otherwise, is otherwise understood within the context as used in general to present that an item, term, etc., may be either X, Y, or Z, or any combination thereof (e.g., X, Y, and/or Z). Thus, such disjunctive language is not generally intended to, and should not, imply that certain embodiments require at least one of X, at least one of Y, or at least one of Z to each be present. Additionally, conjunctive language such as the phrase “at least one of X, Y, and Z,” unless specifically stated otherwise, should also be understood to mean X, Y, Z, or any combination thereof, including “X, Y, and/or Z.”

Illustrative examples of the devices, systems, and methods disclosed herein are provided below. An embodiment of the devices, systems, and methods may include any one or more, and any combination of, the examples described below.

Example 1 includes one or more examples, and includes a non-transitory computer-readable medium comprising instructions stored thereon, that if executed by one or more processors, cause the one or more processors to: select a compute node to execute a function based on latency of retrievals of function data blocks, wherein the function data blocks comprise at least a portion of an image of the function and the function data blocks are stored among two or more tiers of storage.

Example 2 includes one or more examples, and includes instructions stored thereon, that if executed by one or more processors, cause the one or more processors to: determine latency of retrievals of function data blocks is based on storage of the function data blocks in devices of one or more storage tiers and retrieval latency to a memory utilized to launch the function.

Example 3 includes one or more examples, and includes instructions stored thereon, that if executed by one or more processors, cause the one or more processors to: determine one or more candidate nodes to execute the function based on hardware and/or software resource parameters of the function.

Example 4 includes one or more examples, wherein the select a compute node to execute the function based on the determined latency of accesses to container data blocks is also based on the determined one or more candidate nodes.

Example 5 includes one or more examples, and includes instructions stored thereon, that if executed by one or more processors, cause the one or more processors to: store at least one data block into a tier of storage based on one or more of: access frequency of the data block, sequence of access of the data block, and number of functions executing on the selected compute node that access the data block.

Example 6 includes one or more examples, wherein the access frequency of the data block and sequence of access of the data block are based on at least one prior execution of the function.

Example 7 includes one or more examples, wherein the one or more tiers of storage comprise memory and/or storage devices in a hierarchical storage system.

Example 8 includes one or more examples, and includes an apparatus that includes: at least one processor; at least one memory comprising instructions stored thereon, that if executed by the at least one processor, cause the at least one processor to: select a compute node to execute a function based on latency of retrievals of function data blocks, wherein the function data blocks comprise at least a portion of an image of the function and the function data blocks are stored among two or more tiers of storage.

Example 9 includes one or more examples, wherein the latency of retrievals of function data blocks is based on storage of the function data blocks in devices of one or more storage tiers and retrieval latency to a memory utilized to launch the function.

Example 10 includes one or more examples, wherein the at least one memory comprises instructions stored thereon, that if executed by the at least one processor, cause the at least one processor to: determine one or more candidate nodes to execute the function based on hardware and/or software resource parameters of the function.

Example 11 includes one or more examples, wherein the select a compute node to execute the function based on the latency of retrievals of function data blocks is also based on the determined one or more candidate nodes.

Example 12 includes one or more examples, wherein the at least one memory comprises instructions stored thereon, that if executed by the at least one processor, cause the at least one processor to: store at least one data block into a tier of storage based on one or more of: access frequency of the data block, sequence of access of the data block, and number of functions executing on the selected compute node that access the data block.

Example 13 includes one or more examples, wherein the access frequency of the data block and sequence of access of the data block are based on at least one prior execution of the function.

Example 14 includes one or more examples, and includes a server, wherein the server comprises at least one memory and/or storage device corresponding to the one or more tiers of storage and the at least one memory and/or storage device is to store the function data blocks.

Example 15 includes one or more examples, and includes a method that includes: in a cloud computing cluster with hierarchical storage, selecting a node to execute a function instance based on a distribution pattern of function image data segments in the hierarchical storage to reduce a time to access function image data segments during start-up and execution of the function instance.

Example 16 includes one or more examples, wherein the function image data segments comprise at least a portion of an image of the function instance.

Example 17 includes one or more examples, and includes determining latency of retrievals of function image data segments to a memory utilized to launch the function instance.

Example 18 includes one or more examples, and includes determining one or more candidate nodes to execute the function instance based on hardware and/or software resource parameters of the function instance.

Example 19 includes one or more examples, wherein the selecting a node to execute a function instance based on a distribution pattern of function image data segments in the hierarchical storage to reduce a time to access function image data segments during start-up and execution of the function instance is based on the determined one or more candidate nodes.

Example 20 includes one or more examples, and includes storing the function image data segments into one or more storage devices based on one or more of: access frequency of the data block, sequence of access of the data block, and number of functions executing on the selected node that access the data block.

What is claimed is:

1. A non-transitory computer-readable medium comprising instructions stored thereon, that if executed by one or more processors, cause the one or more processors to:
select a compute node to execute a function based on latency of retrievals of function data blocks, wherein the function data blocks comprise at least a portion of an image of the function and the function data blocks are stored among two or more tiers of storage.

2. The computer-readable medium of claim 1, comprising instructions stored thereon, that if executed by one or more processors, cause the one or more processors to:
determine latency of retrievals of function data blocks is based on storage of the function data blocks in devices of one or more storage tiers and retrieval latency to a memory utilized to launch the function.

3. The computer-readable medium of claim 2, comprising instructions stored thereon, that if executed by one or more processors, cause the one or more processors to:
determine one or more candidate nodes to execute the function based on hardware and/or software resource parameters of the function.

4. The computer-readable medium of claim 3, wherein the select a compute node to execute the function based on the determined latency of accesses to container data blocks is also based on the determined one or more candidate nodes.

5. The computer-readable medium of claim 1, comprising instructions stored thereon, that if executed by one or more processors, cause the one or more processors to:
store at least one data block into a tier of storage based on one or more of: access frequency of the data block, sequence of access of the data block, and number of functions executing on the selected compute node that access the data block.

6. The computer-readable medium of claim 5, wherein the access frequency of the data block and sequence of access of the data block are based on at least one prior execution of the function.

7. The computer-readable medium of claim 1, wherein the one or more tiers of storage comprise memory and/or storage devices in a hierarchical storage system.

8. An apparatus comprising:
at least one processor;
at least one memory comprising instructions stored thereon, that if executed by the at least one processor, cause the at least one processor to:
select a compute node to execute a function based on latency of retrievals of function data blocks, wherein the function data blocks comprise at least a portion of an image of the function and the function data blocks are stored among two or more tiers of storage.

9. The apparatus of claim 8, wherein the latency of retrievals of function data blocks is based on storage of the function data blocks in devices of one or more storage tiers and retrieval latency to a memory utilized to launch the function.

10. The apparatus of claim 8, wherein the at least one memory comprises instructions stored thereon, that if executed by the at least one processor, cause the at least one processor to:
determine one or more candidate nodes to execute the function based on hardware and/or software resource parameters of the function.

11. The apparatus of claim 10, wherein the select a compute node to execute the function based on the latency of retrievals of function data blocks is also based on the determined one or more candidate nodes.

12. The apparatus of claim 8, wherein the at least one memory comprises instructions stored thereon, that if executed by the at least one processor, cause the at least one processor to:
store at least one data block into a tier of storage based on one or more of: access frequency of the data block, sequence of access of the data block, and number of functions executing on the selected compute node that access the data block.

13. The apparatus of claim 12, wherein the access frequency of the data block and sequence of access of the data block are based on at least one prior execution of the function.

14. The apparatus of claim 8, comprising a server, wherein the server comprises at least one memory and/or storage device corresponding to the one or more tiers of storage and the at least one memory and/or storage device is to store the function data blocks.

15. A method comprising:
in a cloud computing cluster with hierarchical storage, selecting a node to execute a function instance based on a distribution pattern of function image data segments in the hierarchical storage to reduce a time to access function image data segments during start-up and execution of the function instance.

16. The method of claim 15, wherein the function image data segments comprise at least a portion of an image of the function instance.

17. The method of claim 15, comprising:
determining latency of retrievals of function image data segments to a memory utilized to launch the function instance.

18. The method of claim 15, comprising:
determining one or more candidate nodes to execute the function instance based on hardware and/or software resource parameters of the function instance.

19. The method of claim 18, wherein the selecting a node to execute a function instance based on a distribution pattern of function image data segments in the hierarchical storage to reduce a time to access function image data segments during start-up and execution of the function instance is based on the determined one or more candidate nodes.

20. The method of claim 15, comprising:
storing the function image data segments into one or more storage devices based on one or more of: access frequency of the data block, sequence of access of the data block, and number of functions executing on the selected node that access the data block.
